(19) United States
(12) Patent Application Publication
(10) Pub. No.: US 2023/0402002 A1
(43) Pub. Date: Dec. 14, 2023

(54) PIXEL DRIVING CIRCUIT, PIXEL DRIVING METHOD AND DISPLAY PANEL

(71) Applicant: HKC CORPORATION LIMITED, Shenzhen (CN)

(72) Inventors: Renjie ZHOU, Shenzhen (CN); Haijiang YUAN, Shenzhen (CN)

(21) Appl. No.: 18/067,460

(22) Filed: Dec. 16, 2022

(30) Foreign Application Priority Data
Jun. 8, 2022 (CN) 202210638239.6

(51) Int. Cl. G09G 3/3208

(52) U.S. Cl. CPC G09G 3/3208; G09G 2300/0819; G09G 2310/0202; G09G 2310/08; G09G 2310/0254; G09G 2330/021; G09G 2300/0426

(57) ABSTRACT

A pixel driving circuit includes a first pixel circuit and a second pixel circuit. The first pixel circuit and the second pixel circuit are respectively connected to a first scan line and a second scan line and a first data line and a second data line with opposite polarities. The pixel driving circuit further includes a charge share switch, a control terminal of the charge share switch is connected to the second scan line, a first terminal of the charge share switch is connected to the first pixel circuit, and a second terminal of the charge share switch is connected to the second pixel circuit.

### CROSS-REFERENCE TO RELATED APPLICATION

This application claims priority to Chinese Patent Application No. 202210638239.6, filed Jun. 8, 2022, the entire disclosure of which is incorporated herein by reference.

### FIELD OF TECHNOLOGY

The present disclosure relates to the display technology field and, more particularly, to a pixel driving circuit, a pixel driving method and a display panel.

### BACKGROUND

Organic light-emitting diode (OLED) display panel has been widely used in the field of high-performance display because of its high brightness, wide viewing angle, fast response speed and low power consumption.

However, in the process of continuously reversing the polarity of data lines, the power supply will be continuously consumed, resulting in waste of resources.

### SUMMARY

There are provided a pixel driving circuit, a pixel driving method and a display panel according to embodiments of the present disclosure. The technical solution is as below:

According to a first aspect of the present disclosure, there is provided a pixel driving circuit, which includes:
a first pixel circuit including a first transistor, a first driving transistor, a first capacitor and a first light-emitting element, a control terminal of the first transistor being connected to a first scan line, a first terminal of the first transistor being connected to the first data line, a second terminal of the first transistor, a control terminal of the first driving transistor and a first terminal of the first capacitor being connected to a first node A, a first terminal of the first driving transistor being connected to a first power supply signal terminal, a second terminal of the first driving transistor being connected to a first terminal of the first light-emitting element, and second terminals of the first light-emitting element and the first capacitor being connected to a second power supply signal terminal;
a second pixel circuit including a second transistor, a second driving transistor, a second capacitor and a second light-emitting element, a control terminal of the second transistor being connected to a second scan line, a first terminal of the second transistor being connected to a second data line, a second terminal of the second transistor, a control terminal of the second driving transistor and a first terminal of the second capacitor being connected to a second node B, a first terminal of the second driving transistor being connected to the first power supply signal terminal, a second terminal of the second driving transistor being connected to a first terminal of the second light-emitting element, second terminals of the second light-emitting element and the second capacitor being connected to a third power supply signal terminal, and
a polarity of the second data line being opposite to a polarity of the first data line; and a charge share switch, a control terminal of the charge share switch being connected to a third scan line, a first terminal of the charge share switch being connected to the first node A, a second terminal of the charge share switch being connected to the second node B, and the control terminal of the charge share switch being capable of responding to a scan signal of the third scan line to enable the first node A to be connected to the second node B.

According to a second aspect of the present disclosure, there is provided a pixel driving method for driving a pixel circuit as described above, the pixel driving method includes: in a charging phase, turning on the first transistor with the scan signal of the first scan line, turning on the second transistor with the scan signal of the second scan line, and turning off the charge share switch with the scan signal of the third scan line; in a light enable phase, turning off the first transistor with the scan signal of the first scan line, turning off the second transistor with the scan signal of the second scan line, and turning off the charge share switch with the scan signal of the third scan line; and in a data polarity switching phase, turning on the charge share switch with the scan signal of the third scan line, then turning off the first transistor with the scan signal of the first scan line, and turning off the second transistor with the scan signal of the second scan line.

According to a third aspect of the present disclosure, there is provided a display panel including a pixel unit and the pixel circuit of any one described above, the pixel circuit corresponds to the pixel unit one to one.

It should be understood that the above general description and the following detailed description are exemplary and explanatory only and are not intended to limit the present disclosure.

### BRIEF DESCRIPTION OF THE DRAWINGS

The accompanying drawings, which are incorporated in and constitute a part of the specification, illustrate embodiments consistent with the present disclosure and, together with the description, serve to explain the principles of the present disclosure. Obviously, the drawings in the following description are merely some embodiments of the present disclosure, from which other drawings may be obtained without exerting inventive effort by those ordinarily skilled in the art.

FIG. 1 is a schematic diagram of a pixel driving circuit according to embodiment 1 of the present disclosure.

FIG. 2 is a structural schematic diagram of a first pixel circuit and a second pixel circuit provided with inverters according to the first embodiment of the present disclosure.

FIG. 3 illustrates a process of data voltage variation in data line polarity according to embodiment 1 of the present disclosure.

FIG. 4 shows polarity changes of data lines with different frame numbers according to embodiment 1 of the present disclosure.

FIG. 5 is a flow diagram of a pixel driving method according to embodiment 2 of the present disclosure.

FIG. 6 is a flow diagram of a pixel driving method for adding an inverter according to embodiment 2 of the present disclosure.

FIG. 7 shows a potential of each scan line at different time sequences

according to embodiment 1 of the present disclosure.

FIG. 8 is a structural schematic diagram of a charging phase according to embodiment 2 of the present disclosure.

FIG. 9 is a structural schematic diagram of a light enable phase according to embodiment 2 of the present disclosure.

FIG. 10 is a structural schematic diagram of a data polarity switching phase according to embodiment 2 of the present disclosure.

FIG. 11 is a structural schematic diagram of a pixel circuit added with an inverter in the charging phase according to embodiment 2 of the present disclosure.

FIG. 12 is a structural schematic diagram of a pixel circuit added with an inverter in the light enable phase according to embodiment 2 of the present disclosure.

FIG. 13 is a structural schematic diagram of a pixel circuit added with an

inverter in a data polarity switching phase according to embodiment 2 of the present disclosure.

### DETAILED DESCRIPTION OF THE EMBODIMENTS

The exemplary embodiments will now be described more fully with

reference to the accompanying drawings. However, the example embodiments can be implemented in a variety of forms and should not be construed as being limited to the examples set forth herein. Rather, these embodiments are provided so that the present disclosure will be more comprehensive and complete, and the concept of example embodiments will be fully communicated to those skilled in the art.

In the disclosure, the terms of “first”, “second” are for descriptive purposes only and cannot be construed as indicating or implying relative importance or implying the number of the indicated technical features. Thus, features defined with “first” and “second” may explicitly or implicitly include one or more of the features. In the description of the present disclosure, “multiple” means two or more unless otherwise expressly specified.

In the present disclosure, the terms “install”, “connect” and the like are to be understood in a broad sense, unless otherwise expressly specified and limited, for example, it can be a fixed connection, may also be a detachable connection, or be integral; it can be a mechanical connection, can also be an electrical connection; it can be directly connection or indirectly connection through an intermediate medium, or it can be an internal connection of two elements or an interactive relationship of two elements. For those ordinarily skilled in the art, the specific meanings of the above terms in the present disclosure will be understood according to the specific circumstances.

Further, the described features, structures or characteristics may be incorporated in any suitable manner in one or more embodiments. In the following description many specific details are provided to give a full understanding of the embodiments of the present disclosure. However, those skilled in the art will appreciate that the technical aspects of the present disclosure may be practiced without one or more of the specific details, or other methods, components, devices, steps and the like may be employed. In other instances, the common methods, device, implementations or operations are not shown or described in detail to avoid obscuring aspects of the present disclosure.

### Embodiment 1

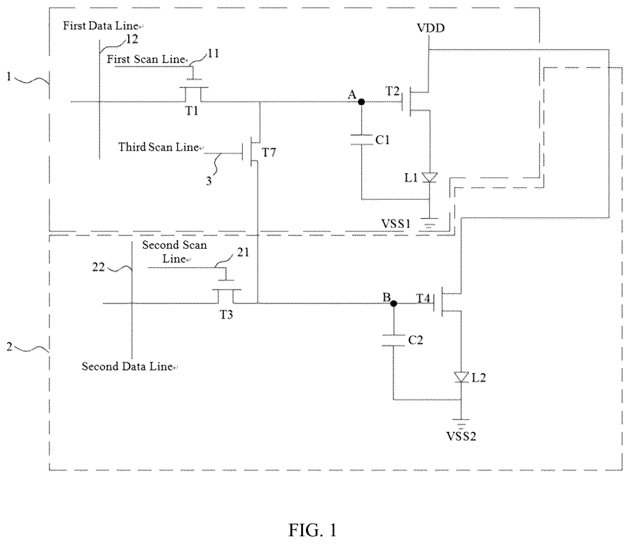

Referring to FIG. 1, an embodiment of the present disclosure provides a pixel driving circuit including a first pixel circuit 1, a second pixel circuit 2, and a charge share switch T7.

As shown in FIG. 1, the first pixel circuit 1 includes a first transistor T1, a first driving transistor T2, a first capacitor C1 and a first light-emitting element L1. A control terminal of the first transistor T1 is connected to a first scan line 11, a first terminal of the first transistor T1 is connected to a first data line 12, the first transistor T1 is used for receiving a scan signal of the first scan line 11 (i.e., the first scan signal Scan1) to input the first data signal DATA1 of the first data line 12 to the first capacitor C1. A second terminal of the first transistor T1, a control terminal of the first driving transistor T2 and a first terminal of the first capacitor C1 are connected to a first node A, that is, the voltage value corresponding to the first data signal DATA1 is transmitted to the first node A. A first terminal of the first driving transistor T2 is connected to a first power supply signal terminal VDD, a second terminal of the first driving transistor T2 is connected to a first terminal of the first light-emitting element L1, and second terminals of the first light-emitting element L1 and the first capacitor C1 are connected to a second power supply signal terminal VSS1.

Referring to FIG. 1, the second pixel circuit 2 includes a second transistor T3, a second driving transistor T4, a second capacitor C2 and a second light-emitting element L2. A control terminal of the second transistor T3 is connected to a second scan line 21, a first terminal of the second transistor T3 is connected to a second data line 22, and the second transistor T3 is used for receiving a scan signal of the second scan line 21 (i.e., a second scan signal Scan2) to input a second data signal DATA2 of the second data line 22 to the second capacitor C2. A second terminal of the second transistor T3, a control terminal of the second driving transistor T4 and a first terminal of the second capacitor C2 are connected to a second node B. That is, the voltage value corresponding to the second data signal DATA2 is transmitted to the second node B. A first terminal of the second driving transistor T4 is connected to the first power supply signal terminal VDD, a second terminal of the second driving transistor T4 is connected to the first terminal of the second light-emitting element L2, second terminals of the second light-emitting element L2 and the second capacitor C2 are connected to a third power supply signal terminal VSS2, and a polarity of the second data line 22 is opposite to that of the first data line 12.

Referring to FIG. 1, the control terminal of the charge share switch T7 is connected to the third scan line 3, a first terminal of the charge share switch T7 is connected to the first node A, a second terminal of the charge share switch T7 is connected to the second node B, and a control terminal of the charge share switch T7 can respond to a scan signal of the third scan line 3 (i.e., the third scan signal Scan3) to enable the first node A to be connected to the second node B.

It should be noted that the polarity of the first data line 12 being opposite to that of the second data line 22, that means, the voltage value corresponding to the first data signal DATA1 provided by the first data line 12 and the voltage value corresponding to the second data signal DATA2 provided by the second data line 22 are opposite numbers with each other. For example, the voltage value corresponding to the first data signal DATA1 is positive and the voltage value corresponding to the second data signal DATA2 is negative. The voltage value corresponding to the first data signal DATA1 is negative, and the voltage value corresponding to the second data signal DATA2 is positive.

Specifically, the control terminal of the charge share switch T7 is used for receiving the third scan signal Scan3 sent by the third scan line 3. When the charge share switch T7 is conducted, the first node A is connected to the second node B, so that the voltage value at the first node A and the voltage value at the second node B become the average value V_{average} between them. When it is necessary to reverse the polarity of the first data line 12 and the second data line 22, that is, to change from the average value V_{average}, so that it is easier reach the target voltage V_{target} of the first data line 12 and the second data line 22 without changing from the current voltage V_{current} to the target voltage V_{target}, thus eliminating reversing of voltage and further achieving the purpose of saving power.

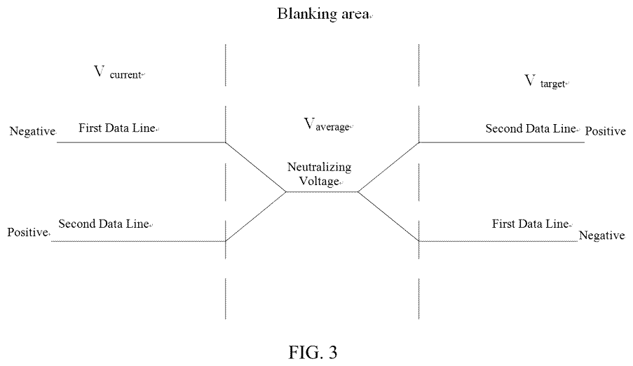

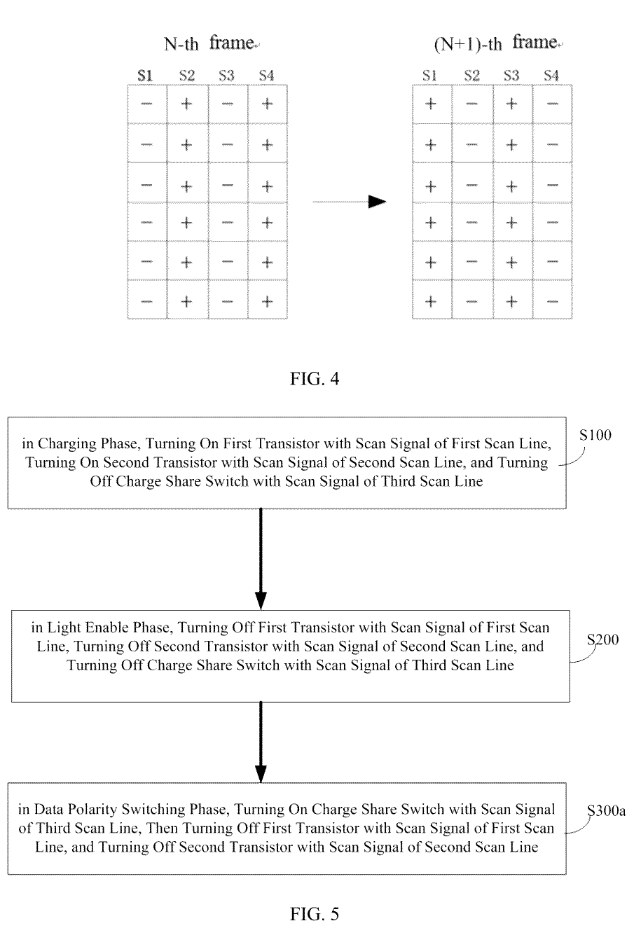

For example, referring to FIGS. 1, 3 and 4, when the voltage value corresponding to the first data signal DATA1 is positive and the voltage value corresponding to the second data signal DATA2 is negative at the time of N-th frame, the first node A and the second node B are communicated through the charge share switch T7 so that the voltage value V1 at the first node A and the voltage value at the second node B become the average value V_{average} between them. When polarity inversion is performed in a blanking area, the voltage value corresponding to the first data signal DATA1 changes from the average value V_{average} to a negative value, and the voltage value corresponding to the second data signal DATA2 changes from the V_{average} to a positive voltage value, and then enters the (N+1)-th frame. Where N is an integer greater than 1. Compared with the voltage value corresponding to the first data signal DATA1 changing from a positive value to a negative value and the voltage value corresponding to the second data signal DATA2 changing from a negative value to a positive value, the inverse voltage consumed is less, thereby achieving the purpose of saving power.

The present disclosure discloses a pixel driving circuit, a pixel driving method and a display panel, which can be used for saving power. The pixel driving circuit includes a first pixel circuit and a second pixel circuit respectively connected to a first data line and a second data line with opposite polarities, and a charge share switch disposed in the first pixel circuit and the second pixel circuit; the charge share switch neutralizes the voltages of the first data line and the second data line, such that the voltages of the first data line and the second data line return to the intermediate value, and when the voltages are reversed, the voltage starting points of the first data line and the second data line become the intermediate value, so that the target voltage can be more easily achieved, and the purpose of saving electricity can be achieved.

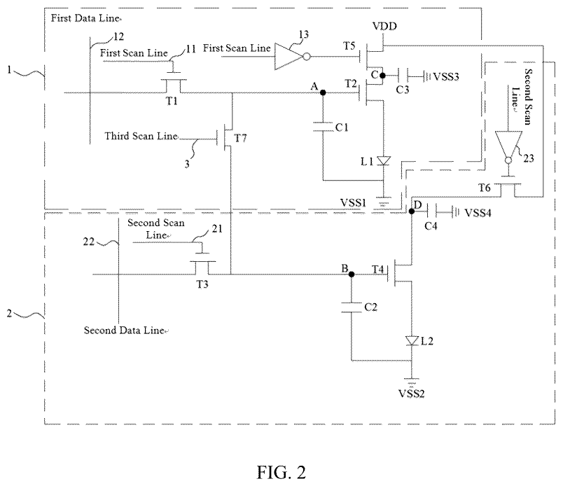

In addition, as shown in FIG. 2, the first pixel circuit further includes a third transistor T5, a third capacitor C3 and a first inverter 13. The control terminal of the third transistor T5 is connected to the first scan line 11, a first terminal of the third transistor T5 is connected to the first power supply signal terminal VDD, a second terminal of the third transistor T5, the first terminal of the first driving transistor T2 and a first terminal of the third capacitor C3 are connected to the third node C, and a second terminal of the third capacitor C3 is connected to the fourth power supply signal terminal VSS3. An input terminal of the first inverter 13 is connected to one end of the first scan line 11, and an output terminal of the first Inverter 13 is connected to a control terminal of the third transistor T5.

The second pixel circuit 2 further includes a fourth transistor T6, a fourth capacitor C4 and a second inverter 23. A control terminal of the fourth transistor T6 is connected to the second scan line 21, a first terminal of the fourth transistor T6 is connected to a first power supply signal terminal VDD, a second terminal of the fourth transistor T6, a first terminal of the second driving transistor T4 and the first terminal of the fourth capacitor C4 are connected to the fourth node D, a second terminal of the fourth capacitor C4 is connected to the fifth power supply signal terminal VSS4, an input terminal of the second inverter 23 is connected to one end of the second scan line 21, and an output terminal of the second inverter 23 is connected to the control terminal of the fourth transistor T6.

The first inverter 13 and the second inverter 23 can adjust the scan signals inputted from the first scan line 11 and the second scan line 21, that is, levels of the first scan signal Scan1 and the second scan signal Scan2 can be adjusted. For example, when the first scan signal Scan1 is at the low level, the first scan signal Scan1 is converted to the high level after passing through the first inverter 13. When the first scan signal Scan1 is at the high level, the first scan signal Scan1 is converted to the low level after passing through the first inverter 13. That is, the first scan signal Scan1 controls the conduction of the third transistor T5 via the first inverter 13. The second scan signal Scan2 controls the conduction of the fourth transistor T6 via the second inverter 23.

When data polarity switching is not performed, the third transistor T5 and the fourth transistor T6 receive the second scan signal Scan1 and the second scan signal Scan2 respectively and are turned on, and the first power supply signal is input to the third capacitor C3 and the fourth capacitor C4 for storing electricity. The first power supply signal terminal VDD is disconnected at the same time of data polarity switching, the third transistor T5 and the fourth transistor T6 receive the first scan signal Scan1 and the second scan signal Scan2, respectively, to control the third transistor T5 and the fourth transistor T6 to turn off. The third capacitor C3 and the fourth capacitor discharge to the third node C and the fourth node D, respectively, to supplement the voltage at the second terminals of the third transistor T5 and the fourth transistor T6 to drive the first driving transistor T2 and the second driving transistor T4 to turn on, so that the first light-emitting element L1 and the second light-emitting element L2 emit light. The first inverter 13, the second inverter 23, the third capacitor C3 and the fourth capacitor C4 can achieve the second power saving effect, and can also reduce the power consumption of the first power supply signal terminal VDD and reduce the use cost. In addition, the first light-emitting element L1 and the second light-emitting element L2 can be protected to a certain extent.

It should be understood that the first transistor T1, the second transistor T3, the third transistor T5, the fourth transistor T6, and the charge share switch T7 each has a first terminal, a second terminal, and a control terminal, like the first driving transistor T2 and the second driving transistor T4. The control terminal of each transistor corresponds to the gate electrode of the transistor, one of the first terminal and the second terminal corresponds to the source electrode of the transistor, and the other corresponds to the drain electrode of the transistor.

By way of example, the first driving transistor T2, the second driving transistor T4, the first transistor T1, the second transistor T3, the third transistor T5, the fourth transistor T6 and the charge share switch T7 of the embodiment of the present disclosure may all be oxide thin film transistors. That is, the material of the active layer of each transistor may be an oxide, for example, a metal oxide material such as IGZO (Indium Gallium Zinc Oxide) or a Si (amorphous silicon) thin film transistor may be used, which may be designed according to different embodiments.

For example, each transistor may be of a bottom gate type, i.e., the gate of the transistor is located below the active layer (side close to the glass substrate) to allow appropriate thinning of the product, but is not limited thereto, and each transistor may also be of a top gate type, depending on the specific case.

Further, each transistor may be an enhancement or a depletion transistor, which is not specifically limited by the embodiments of the present disclosure.

By way of example, all transistors in the pixel driving circuit may be N-type thin film transistors, that is, the first driving transistor T2, the second driving transistor T4, the first transistor T1, the second transistor T3, the third transistor T5, the fourth transistor T6 and the charge share switch T7 may all be N-type thin film transistors, and the driving voltage of each transistor corresponds to a high-level voltage. The first power supply signal input from the first power supply signal terminal VDD may be a DC high-level signal, and the second power supply signal input from the second power supply signal terminal VSS1, the third power supply signal input from the third power supply signal terminal VSS2, the fourth power supply signal input from the fourth power supply signal terminal VSS3 and the fifth power supply signal input from the fifth power supply signal terminal VSS4 may be DC low-level signals.

It should be understood that the transistors in the pixel driving circuit are not limited to the N-type thin film transistor mentioned above, but may be all P-type thin film transistors or partially N-type thin film transistors and partially P-type thin film transistors. When the transistor is a P-type thin film transistor, its driving voltage can correspond to a low-level voltage.

For example, the first light-emitting element L1 may be a current-driven light-emitting element L which is controlled to emit light by a current flowing through the first driving transistor T2. The second light-emitting element L2 may be a current-driven light-emitting element, which is controlled to emit light by a current flowing through the second driving transistor T4. For example, the first light-emitting element L1 and the second light-emitting element L2 may be organic light-emitting diodes (OLED), that is, the pixel driving circuit may be applied to an OLED display device. The first terminal of the first light-emitting element L1 is an anode of the OLED, and the second terminal of the first light-emitting element L1 is a cathode of the OLED. The first terminal of the second light-emitting element L2 is an anode of the OLED, and the second terminal of the second light-emitting element L2 is a cathode of the OLED. That is, the anode of the organic light-emitting diode in the first pixel circuit 1 is connected to the second terminal of the first driving transistor T2, and the cathode of the organic light-emitting diode in the first pixel circuit 1 is connected to the second power supply signal terminal VSS1. An anode of the organic light-emitting diode in the second pixel circuit 2 is connected to the second terminal of the second driving transistor T4, and a cathode of the organic light-emitting diode in the second pixel circuit 2 is connected to the third power supply signal terminal VSS2.

It should be noted that the first pixel circuit 1 and the second pixel circuit 2 may have a 2T1C structure, a 4T1C structure, a 4T2C structure, or the like, and may be designed according to different display panels.

Further, the first pixel circuit 1 and the second pixel circuit 2 may be located in the same column or in the same row, and may be designed according to different display panels, which is not specifically limited herein. In addition, charge share is not performed between adjacent pixel driving circuits, that is, two pixel circuits perform charge share for a group of the pixel driving circuits.

By way of example, when the first pixel circuit 1 and the second pixel circuit 2 are located in the same column, the first data line 12 and the second data line 22 may be located on the same side of the first pixel circuit 1 and the second pixel circuit 2, or may be located on opposite sides of the first pixel circuit 1 and the second pixel circuit 2.

It should be noted that the display panel includes a display area and a non-display area. The charge share switch T7 is disposed in the non-display area to avoid the charge share switch T7 affecting the display effect of the display panel.

Further, the scanning direction of the pixel driving circuit may be directed from the first row to the last row. For example, the first scan signal Scan1 is supplied by the N-th row scan signal line, and the second scan signal Scan2 is supplied by the (N+1)-th row scan signal line. The third scan signal Scan3 is supplied by the (N+2)-th row scan signal line. It should be understood that N is a positive integer greater than or equal to 1. Since the first to third scan signals Scan3 corresponds to three adjacent scan signal lines, respectively, the circuit configuration can be simplified, the number of scan signal wiring can be reduced, and thus the pixel aperture ratio can be increased.

How it works: when the first capacitor C1 and the second capacitor C2 is charged, the first transistor T1 receives the first scan signal Scan1 of the first scan line 11 and is turned on, the second transistor T3 receives the second scan signal Scan2 of the second scan line 21 and is turned on. The first data signal DATA1 of the first data line 12 and the second data signal DATA2 of the second data line 22 are input to the first node A and the second node B, respectively, so as to charge the first capacitor C1 and the second capacitor C2, and the first capacitor C1 and the second capacitor C2 are charged to voltage values corresponding to the first data signal DATA1 and the second data signal DATA2, and at this time the voltage values flowing through the first driving transistor T2 and the second driving transistor T4 are smaller than the threshold voltage, so that the first light-emitting element L1 and the second light-emitting element L2 do not emit light. In the light enable phase, the first transistor T1 and the second transistor T3 are turned off after receiving the first scan signal Scan' and the second scan signal Scan2, respectively, and the first capacitor C1 and the second capacitor C2 start discharging to drive the first light-emitting element L1 and the second light-emitting element L2 to emit light. When the data polarity is switched to the blanking area, the charge share switch T7 receives the third scan signal Scan3 of the third scan line 3 and is turned on, and the first node A is connected to the second node B, so that the charge stored by the first capacitor C1 and the charge stored by the second capacitor C2 are shared, and then the voltage is neutralized, so that the voltage values at the first node A and the second node B are averaged, namely the average value V_{average}, and the voltage required in the reversion is less, and the purpose of saving electricity is achieved. Further, by neutralizing the voltages on the first data line 12 and the second data line 22, the power consumption of the source line can be reduced and more durable.

It should be understood that the blanking area is the time when there will be a blank frame but not actually displayed during the display of each frame.

Based on this, the pixel driving circuit of the embodiment of the present disclosure adds the charge share switch T7 between two adjacent pixel circuits, which can neutralize the voltage on the data lines with opposite polarities, reduce the starting voltage when the polarity is reversed, and further achieve the function of saving electricity. In addition, an inverter and a capacitor are added in each pixel circuit, which can better protect the light-emitting element, and can also achieve the purpose of saving power for the second time and reduce the power consumption of the first power supply signal.

### Embodiment 2

Referring to FIG. 5, embodiment 2 provides a pixel driving method for driving a pixel circuit as in embodiment 1, and the pixel driving method includes:
step S100, in a charging phase t1, turning on the first transistor T1 with the scan signal of the first scan line 11, turning on the second transistor T3 with the scan signal of the second scan line 21, and turning off the charge share switch T7 with the scan signal of the third scan line 3;
step S200, in a light enable phase t2, turning off the first transistor T1 with the scan signal of the first scan line 11, turning off the second transistor T3 with the scan signal of the second scan line 21, and turning off the charge share switch T7 with the scan signal of the third scan line 3; and
step S300a, in a data polarity switching phase t3, turning on the charge share switch T7 with the scan signal of the third scan line 3, then turning off the first transistor T1 with the scan signal of the first scan line 11, and turning off the second transistor T3 with the scan signal of the second scan line 21.

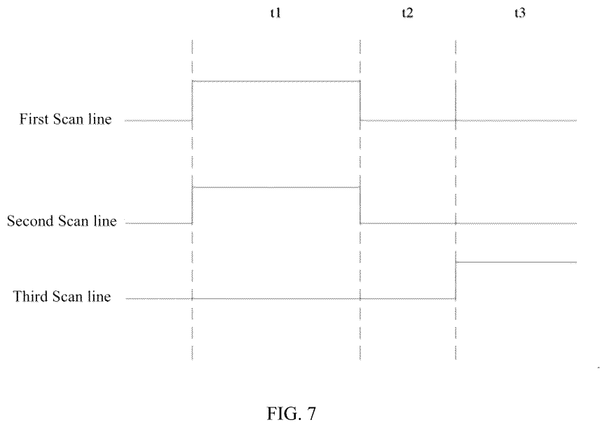

The pixel driving method (i.e., an operating process) corresponding to the pixel driving circuit shown in FIG. 1 or FIG. 2 will be described in detail with reference to an operation timing diagram of the pixel driving circuit shown in FIG. 7.

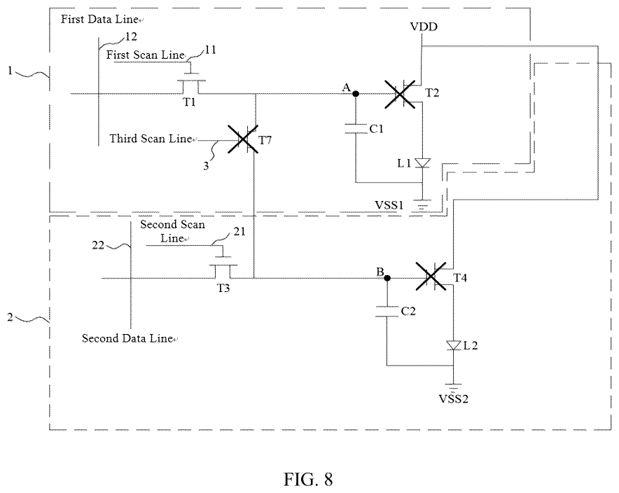

Referring to FIGS. 7, 8, and 11, in the charging phase t1, the first scan signal Scan1 is at the high level, the second scan signal Scan2 is at the high level, and the third scan signal Scan3 is at the low level. The first transistor T1 and the second transistor T3 are turned on, and the charge share switch T7 is turned off. In another embodiments, when the first transistor T1, the second transistor T3 and the charge share switch T7 are P-type thin film transistors, the first scan signal Scan1 and the second scan signal Scan2 are at the low level and the third scan signal Scan3 is at the high level.

At this phase, since the first scan signal Scan1 is at the high level, the second scan signal Scan2 is at the high level, the third scan signal Scan3 is at the low level, i.e., the first transistor T1 and the second transistor T3 are turned on to transmit the first data signal DATA1 in the first data line 12 to the first terminal of the first capacitor C1 and transmit the second data signal DATA2 in the second data line 22 to the first terminal of the second capacitor C2, so as to charge the first capacitor C1 and the second capacitor C2 to Vdata. At this time, the voltages of the first driving transistor T2 and the second driving transistor T4 are smaller than the threshold voltage, and the light-emitting element L does not emit light. Furthermore, the charge share switch T7 is not turned on without charge share.

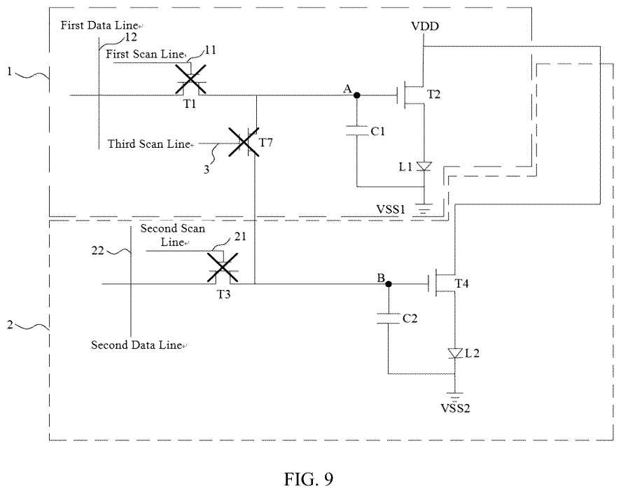

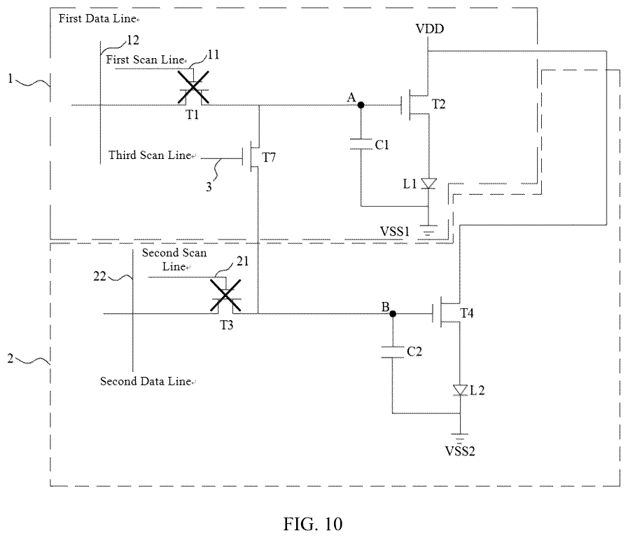

Referring to FIGS. 7, 9, and 12, in the light enable phase t2, the first scan signal Scan1 is at the low level, the second scan signal Scan2 is at the low level, and the third scan signal Scan3 is at the low level. The first transistor T1, the second transistor T3 and the charge share switch T7 are turned off. In another embodiments, when the first transistor T1, the second transistor T3 and the charge share switch T7 are P-type thin film transistors, the first scan signal Scan1, the second scan signal Scan2, and the third scan signal Scan3 are at the high level.

At this phase, since the first scan signal Scan1, the second scan signal Scan2, and the third scan signal Scan3 are all at the low level, that is, the first transistor T1, the second transistor T3, and the charge share switch T7 are all turned off, the first capacitor C1 and the second capacitor C2 are discharged to drive the first driving transistor T2 and the second driving transistor T4 to turn on, so that the first light-emitting element L1 and the second light-emitting element L2 emit light.

Referring to FIGS. 7, 10, and 13, in the data polarity switching phase t3, the first scan signal Scan1 is at the low level, the second scan signal Scan2 is at the low level, and the third scan signal Scan3 is at the high level. The first transistor T1 and the second transistor T3 are turned off, and the charge share switch T7 is turned on. In another embodiments, when the first transistor T1, the second transistor T3 and the charge share switch T7 are P-type thin film transistors, the first scan signal Scan1 and the second scan signal Scan2 are at the high level and the third scan signal Scan3 is at the low level.

At this phase, the charge share switch T7 receives the third scan signal Scan3 of the third scan line 3 and is turned on, connecting the first node A and the second node B, so that the charge stored by the first capacitor C1 and the charge stored by the second capacitor C2 are shared, and then the voltage is neutralized, so that the voltage values at the first node A and the second node B are averaged at the average value V_{average}, and the voltage required in the reversion is less, and the purpose of saving electricity is achieved. Further, by neutralizing the voltages on the first data line 12 and the second data line 22, the power consumption of the source line can be reduced and more durable.

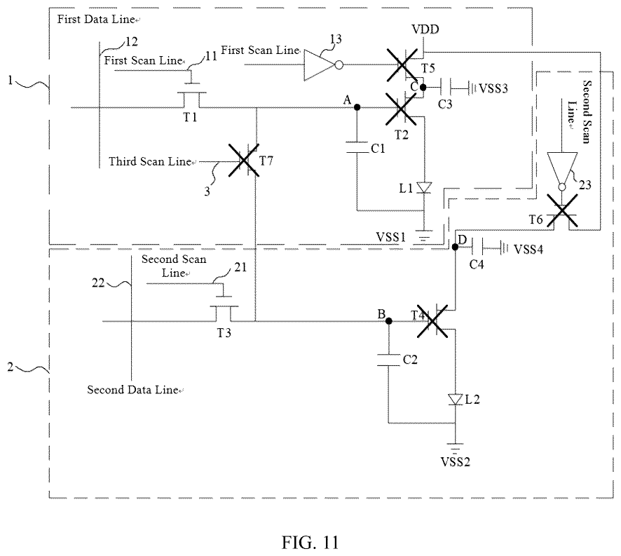

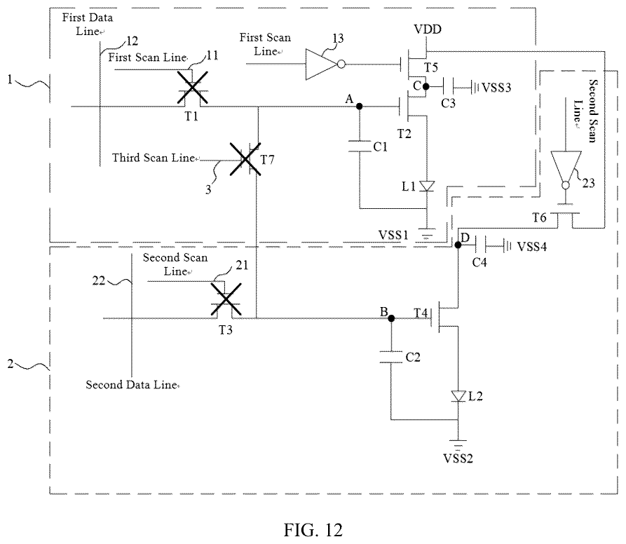

In addition, as shown in FIGS. 11, 12 and 13, the first pixel circuit further includes a third transistor T5, a third capacitor C3 and a first inverter 13. The control terminal of the third transistor T5 is connected to the first scan line 11, a first terminal of the third transistor T5 is connected to the first power supply signal terminal VDD, a second terminal of the third transistor T5, the first terminal of the first driving transistor T2 and a first terminal of the third capacitor C3 are connected to the third node C, and a second terminal of the third capacitor C3 is connected to the fourth power supply signal terminal VSS3. An input terminal of the first inverter 13 is connected to one end of the first scan line 11, and an output terminal of the first inverter 13 is connected to a control terminal of the third transistor T5. The second pixel circuit 2 further includes a fourth transistor T6, a fourth capacitor C4 and a second inverter 23. A control terminal of the fourth transistor T6 is connected to the second scan line 21, a first terminal of the fourth transistor T6 is connected to a first power supply signal terminal VDD, a second terminal of the fourth transistor T6, a first terminal of the second driving transistor T4 and the first terminal of the fourth capacitor C4 are connected to the fourth node D, a second terminal of the fourth capacitor C4 is connected to the fifth power supply signal terminal VSS4, an input terminal of the second inverter 23 is connected to one end of the second scan line 21, and an output terminal of the second inverter 23 is connected to the control terminal of the fourth transistor T6.

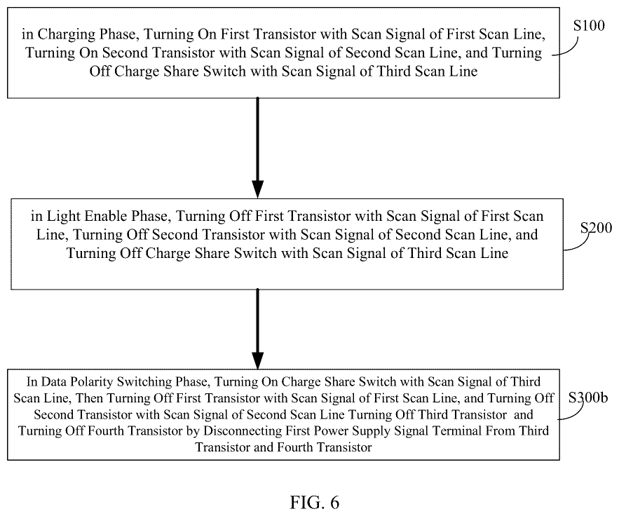

As shown in FIG. 6, the data polarity switching phase further includes turning off the third transistor T5 and turning off the fourth transistor T6 by disconnecting the first power supply signal terminal VDD from the third transistor T5 and the fourth transistor T6. That is, step S300b: in the data polarity switching phase t3, turning on the charge share switch T7 with the scan signal of the third scan line 3, then turning off the first transistor T1 with the scan signal of the first scan line 11, and turning off the second transistor T3 with the scan signal of the second scan line 21; and turning off the third transistor T5 and turning off the fourth transistor T6 with the scan signal of the second scan line 21 by disconnecting the first power supply signal terminal VDD from the third transistor T5 and the fourth transistor T6.

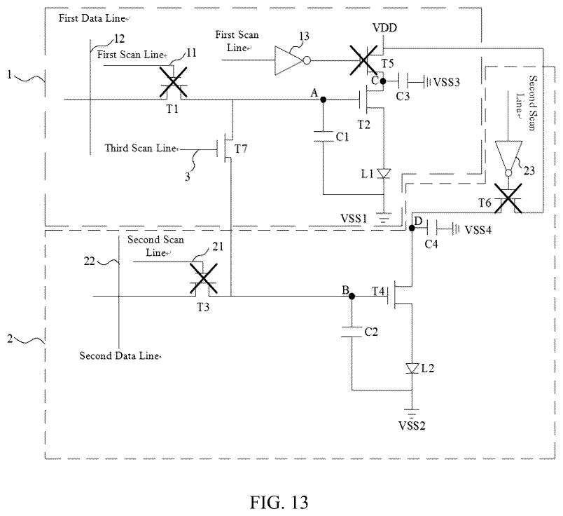

Referring to FIG. 12, when data polarity switching is not performed, the third transistor T5 and the fourth transistor T6 receive the second scan signal Scan1 and the second scan signal Scan2,respectively and are turned on, and input the first power supply signal to the third capacitor C3 and the fourth capacitor C4 for storing electricity. Referring to FIG. 13, the first power supply signal terminal VDD is disconnected at the same time of data polarity switching, to control the third transistor T5 and the fourth transistor T6 to turn off, the third capacitor C3 and the fourth capacitor C4 discharge to the third node C and the fourth node D, respectively, to supplement the voltage at the second terminals of the third transistor T5 and the fourth transistor T6 to drive the first driving transistor T2 and the second driving transistor T4 to turn on, so that the first light-emitting element L1 and the second light-emitting element L2 emit light. The first inverter 13, the second inverter 23, the third capacitor C3 and the fourth capacitor C4 can achieve the second power saving effect, and can also reduce the power consumption of the first power supply signal terminal VDD and reduce the use cost. In addition, the first light-emitting element L1 and the second light-emitting element L2 can be protected to a certain extent.

### Embodiment 3

Embodiment 3 provides a display panel including a pixel unit and the pixel driving circuit mentioned in embodiment 1. The pixel driving circuit corresponds to the pixel unit one to one.

Specifically, the display panel can be any product or component with display function such as an organic light-emitting diode (OLED) display panel, electronic paper, mobile phone, tablet computer, television, display, notebook computer, digital photo frame, navigator, etc.

In addition, the pixel unit includes a display area and a non-display area, and the charge share switch T7 is located in the non-display area in order to ensure the display effect of the display panel.

In the content of the description, illustrations of the reference terms “one embodiment,” “example,” “specific example” etc. mean that specific features, structures, materials, or characteristics described in connection with the embodiment or example are encompassed in at least one embodiment or example of the present disclosure. In this description, the schematic formulation of the above terms need not be directed to the same embodiments or examples. Further, the specific features, structures, materials or characteristics described may be combined in a suitable manner in any one or more embodiments or examples. Further, without contradicting one another, those skilled in the art may connect and combine different embodiments or examples described in this description and features of different embodiments or examples.

Although embodiments of the present disclosure have been shown and

described above, it will be understood that the above-mentioned embodiments are exemplary and cannot be construed as limiting the present disclosure. Those of ordinary skill in the art may make changes, variations, alternatives and modifications to the above-mentioned embodiments within the scope of the present disclosure. Therefore, any changes or modifications made in accordance with the claims and descriptions of the present disclosure should fall within the scope of the patent of the present disclosure.

1. A pixel driving circuit comprising:
a first pixel circuit comprising a first transistor, a first driving transistor, a first capacitor and a first light-emitting element, a control terminal of the first transistor being connected to a first scan line, a first terminal of the first transistor being connected to a first data line, a second terminal of the first transistor, a control terminal of the first driving transistor and a first terminal of the first capacitor being connected to a first node A, a first terminal of the first driving transistor being connected to a first power supply signal terminal, a second terminal of the first driving transistor being connected to a first terminal of the first light-emitting element, and second terminals of the first light-emitting element and the first capacitor being connected to a second power supply signal terminal;
a second pixel circuit comprising a second transistor, a second driving transistor, a second capacitor and a second light-emitting element, a control terminal of the second transistor being connected to a second scan line, a first terminal of the second transistor being connected to a second data line, a second terminal of the second transistor, a control terminal of the second driving transistor and a first terminal of the second capacitor being connected to a second node B, a first terminal of the second driving transistor being connected to the first power supply signal terminal, a second terminal of the second driving transistor being connected to a first terminal of the second light-emitting element, second terminals of the second light-emitting element and the second capacitor being connected to a third power supply signal terminal, and a polarity of the second data line being opposite to a polarity of the first data line; and
a charge share switch, a control terminal of the charge share switch being connected to a third scan line, a first terminal of the charge share switch being connected to the first node A, a second terminal of the charge share switch being connected to the second node B, and the control terminal of the charge share switch being capable of responding to a scan signal of the third scan line to enable the first node A to be connected to the second node B;
when data polarity is switched to a blanking area, the charge share switch receives the third scan signal and is turned on, and the first node A is connected to the second node B, so that the charge stored by the first capacitor and the charge stored by the second capacitor are shared, and then the voltage is neutralized.

2. The pixel driving circuit according to claim 1, wherein the first pixel circuit further comprises a third transistor, a third capacitor and a first inverter, a control terminal of the third transistor being connected to the first scan line, a first terminal of the third transistor being connected to the first power supply signal terminal, a second terminal of the third transistor, the first terminal of the first driving transistor and a first terminal of the third capacitor being connected to a third node C, and a second terminal of the third capacitor being connected to a fourth power supply signal terminal, an input terminal of the first inverter being connected to one end of the first scan line, and an output terminal of the first inverter being connected to the control terminal of the third transistor;
wherein the second pixel circuit further comprises a fourth transistor, a fourth capacitor and a second inverter, a control terminal of the fourth transistor being connected to the second scan line, a first terminal of the fourth transistor being connected to the first power supply signal terminal, a second terminal of the fourth transistor, the first terminal of the second driving transistor and a first terminal of the fourth capacitor being connected to a fourth node D, a second terminal of the fourth capacitor being connected to a fifth power supply signal terminal, an input terminal of the second inverter being connected to one end of the second scan line, and an output terminal of the second inverter being connected to the control terminal of the fourth transistor.

3. The pixel driving circuit according to claim 1, wherein a scan direction of the pixel circuit is directed from a first row to a last row;
wherein the first scan signal is supplied by an N-th row scan line, the second scan signal is supplied by an (N+1)-th row scan line, and the third scan signal is supplied by an (N+2)-th row scan line, where N is a positive integer greater than or equal to 1.

4. The pixel driving circuit according to claim 1, wherein the first light-emitting element and the second light-emitting element are organic light-emitting diodes, an anode of the organic light-emitting diode in the first pixel circuit is connected to the second terminal of the first driving transistor, and a cathode of the organic light-emitting diode in the first pixel circuit is connected to the second power supply signal terminal;
wherein an anode of the organic light-emitting diode in the second pixel circuit is connected to the second terminal of the second driving transistor, and a cathode of the organic light-emitting diode in the second pixel circuit is connected to the third power supply signal terminal.

5. The pixel driving circuit according to claim 1, wherein the first pixel circuit and the second pixel circuit are sequentially arranged in a column direction.

6. The pixel driving circuit according to claim 1, wherein the first pixel circuit and the second pixel circuit are located in the same column or in the same row.

7. The pixel driving circuit according to claim 6, wherein when the first pixel circuit and the second pixel circuit are located in the same column, the first data line and the second data line are located on the same side of the first pixel circuit and the second pixel circuit, or located on opposite sides of the first pixel circuit and the second pixel circuit.

8. The pixel driving circuit according to claim 1, wherein each transistor is of a bottom gate type.

9. A pixel driving method for driving a pixel driving circuit, comprising:
in a charging phase, turning on a first transistor with a scan signal of a first scan line, turning on a second transistor with a scan signal of a second scan line, and turning off a charge share switch with a scan signal of a third scan line;
in a light enable phase, turning off the first transistor with the scan signal of the first scan line, turning off the second transistor with the scan signal of the second scan line, and turning off the charge share switch with the scan signal of the third scan line; and
in a data polarity switching phase, when data polarity is switched to a blanking area turning on the charge share switch with the scan signal of the third scan line, then turning off the first transistor with the scan signal of the first scan line, and turning off the second transistor with the scan signal of the second scan line.

10. The pixel driving method according to claim 9, the pixel driving circuit comprises:
a first pixel circuit comprising the first transistor, a first driving transistor, a first capacitor and a first light-emitting element, a control terminal of the first transistor being connected to the first scan line, a first terminal of the first transistor being connected to a first data line, a second terminal of the first transistor, a control terminal of the first driving transistor and a first terminal of the first capacitor being connected to a first node A, a first terminal of the first driving transistor being connected to a first power supply signal terminal, a second terminal of the first driving transistor being connected to a first terminal of the first light-emitting element, and second terminals of the first light-emitting element and the first capacitor being connected to a second power supply signal terminal;
a second pixel circuit comprising the second transistor, a second driving transistor, a second capacitor and a second light-emitting element, a control terminal of the second transistor being connected to the second scan line, a first terminal of the second transistor being connected to a second data line, a second terminal of the second transistor, a control terminal of the second driving transistor and a first terminal of the second capacitor being connected to a second node B, a first terminal of the second driving transistor being connected to the first power supply signal terminal, a second terminal of the second driving transistor being connected to a first terminal of the second light-emitting element, second terminals of the second light-emitting element and the second capacitor being connected to a third power supply signal terminal, and a polarity of the second data line being opposite to a polarity of the first data line; and
the charge share switch, a control terminal of the charge share switch being connected to the third scan line, a first terminal of the charge share switch being connected to the first node A, a second terminal of the charge share switch being connected to the second node B, and the control terminal of the charge share switch being capable of responding to the scan signal of the third scan line to enable the first node A to be connected to the second node B.

11. The pixel driving method according to claim 10, wherein the first pixel circuit further comprises a third transistor, a third capacitor and a first inverter, a control terminal of the third transistor being connected to the first scan line, a first terminal of the third transistor being connected to the first power supply signal terminal, a second terminal of the third transistor, the first terminal of the first driving transistor and a first terminal of the third capacitor being connected to a third node C, and a second terminal of the third capacitor being connected to a fourth power supply signal terminal, an input terminal of the first inverter being connected to one end of the first scan line, and an output terminal of the first inverter being connected to the control terminal of the third transistor;
wherein the second pixel circuit further comprises a fourth transistor, a fourth capacitor and a second inverter, a control terminal of the fourth transistor being connected to the second scan line, a first terminal of the fourth transistor being connected to the first power supply signal terminal, a second terminal of the fourth transistor, the first terminal of the second driving transistor and a first terminal of the fourth capacitor being connected to a fourth node D, a second terminal of the fourth capacitor being connected to a fifth power supply signal terminal, an input terminal of the second inverter being connected to one end of the second scan line, and an output terminal of the second inverter being connected to the control terminal of the fourth transistor; and
wherein the data polarity switching phase further comprises turning off the third transistor and the fourth transistor by disconnecting the first power supply signal terminal from the third transistor and the fourth transistor.

12. The pixel driving method according to claim 11, wherein in the charging phase, the scan signal of the first scan line and the scan signal of the second scan line are at a high level, and the scan signal of the third scan line is at a low level;
in the light enable phase, the scan signal of the first scan line and the scan signal of the second scan line are at the low level, and the scan signal of the third scan line is at the low level; and
in a data polarity switching phase, the scan signal of the first scan line and the scan signal of the second scan line are at the low level, and the scan signal of the third scan line is at the high level.

13. A display panel comprising:
a pixel unit; and
a pixel driving circuit corresponding to the pixel unit one to one, comprising:
a first pixel circuit comprising a first transistor, a first driving transistor, a first capacitor and a first light-emitting element, a control terminal of the first transistor being connected to a first scan line, a first terminal of the first transistor being connected to a first data line, a second terminal of the first transistor, a control terminal of the first driving transistor and a first terminal of the first capacitor being connected to a first node A, a first terminal of the first driving transistor being connected to a first power supply signal terminal, a second terminal of the first driving transistor being connected to a first terminal of the first light-emitting element, and second terminals of the first light-emitting element and the first capacitor being connected to a second power supply signal terminal;
a second pixel circuit comprising a second transistor, a second driving transistor, a second capacitor and a second light-emitting element, a control terminal of the second transistor being connected to a second scan line, a first terminal of the second transistor being connected to a second data line, a second terminal of the second transistor, a control terminal of the second driving transistor and a first terminal of the second capacitor being connected to a second node B, a first terminal of the second driving transistor being connected to the first power supply signal terminal, a second terminal of the second driving transistor being connected to a first terminal of the second light-emitting element, second terminals of the second light-emitting element and the second capacitor being connected to a third power supply signal terminal, and a polarity of the second data line being opposite to a polarity of the first data line; and
a charge share switch, a control terminal of the charge share switch being connected to a third scan line, a first terminal of the charge share switch being connected to the first node A, a second terminal of the charge share switch being connected to the second node B, and the control terminal of the charge share switch being capable of responding to a scan signal of the third scan line to enable the first node A to be connected to the second node B;
when data polarity is switched to a blanking area, the charge share switch receives the third scan signal and is turned on, and the first node A is connected to the second node B, so that the charge stored by the first capacitor and the charge stored by the second capacitor are shared, and then the voltage is neutralized.

14. The display panel according to claim 13, wherein the pixel unit comprises a display area and a non-display area, and the charge share switch is disposed in the non-display area.

15. The display panel according to claim 13, wherein the first pixel circuit further comprises a third transistor, a third capacitor and a first inverter, a control terminal of the third transistor being connected to the first scan line, a first terminal of the third transistor being connected to the first power supply signal terminal, a second terminal of the third transistor, the first terminal of the first driving transistor and a first terminal of the third capacitor being connected to a third node C, and a second terminal of the third capacitor being connected to a fourth power supply signal terminal, an input terminal of the first inverter being connected to one end of the first scan line, and an output terminal of the first inverter being connected to the control terminal of the third transistor;
wherein the second pixel circuit further comprises a fourth transistor, a fourth capacitor and a second inverter, a control terminal of the fourth transistor being connected to the second scan line, a first terminal of the fourth transistor being connected to the first power supply signal terminal, a second terminal of the fourth transistor, the first terminal of the second driving transistor and a first terminal of the fourth capacitor being connected to a fourth node D, a second terminal of the fourth capacitor being connected to a fifth power supply signal terminal, an input terminal of the second inverter being connected to one end of the second scan line, and an output terminal of the second inverter being connected to the control terminal of the fourth transistor.

16. The display panel according to claim 13, wherein a scan direction of the pixel circuit is directed from a first row to a last row;
wherein the first scan signal is supplied by an N-th row scan line, the second scan signal is supplied by an (N+1)-th row scan line, and the third scan signal is supplied by an (N+2)-th row scan line, where N is a positive integer greater than or equal to 1.

17. The display panel according to claim 13, wherein the first light-emitting element and the second light-emitting element are organic light-emitting diodes, an anode of the organic light-emitting diode in the first pixel circuit is connected to the second terminal of the first driving transistor, and a cathode of the organic light-emitting diode in the first pixel circuit is connected to the second power supply signal terminal;
wherein an anode of the organic light-emitting diode in the second pixel circuit is connected to the second terminal of the second driving transistor, and a cathode of the organic light-emitting diode in the second pixel circuit is connected to the third power supply signal terminal.

18. The display panel according to claim 13, wherein the first pixel circuit and the second pixel circuit are sequentially arranged in a column direction.

19. The display panel according to claim 13, wherein the first pixel circuit and the second pixel circuit are located in the same column or in the same row.

20. The display panel according to claim 19, wherein when the first pixel circuit and the second pixel circuit are located in the same column, the first data line and the second data line are located on the same side of the first pixel circuit and the second pixel circuit, or located on opposite sides of the first pixel circuit and the second pixel circuit.
